(19) United States
(12) Patent Application Publication
(10) Pub. No.: US 2015/0125202 A1
(43) Pub. Date: May 7, 2015

(54) CONNECTING HOLE HAVING A TEETH-LIKE CONFIGURATION

(71) Applicant: Michael Chau-Lun CHANG, Taipei City (TW)

(72) Inventor: Michael Chau-Lun CHANG, Taipei City (TW)

(21) Appl. No.: 14/526,527

(22) Filed: Oct. 29, 2014

(30) Foreign Application Priority Data
Nov. 5, 2013 (TW) 102140084

(51) Int. Cl. F16B 21/02

(52) U.S. Cl. CPC F16B 21/02
USPC 403/348

(57) ABSTRACT

A connecting hole having a teeth-like configuration, disposed on a female connecting article for connecting a male connecting article, includes a plurality of tooth portions spaced apart from each other and arranged radially about a center of the connecting hole at a predetermined angle. The male connecting article includes a connecting element formed with multiple circumferentially outwardly projecting portions corresponding in position to the plurality of tooth portions so as to allow the multiple circumferentially outwardly projecting portions to pass through the connecting hole and to be positioned by rotation of the male connecting article, such that the multiple projecting portions abut against a side surface of the connecting hole, and an outer periphery of the connecting element is in frictional contact with an inner periphery of the connecting hole.

### BACKGROUND OF THE INVENTION

1. Field of the Invention

The present invention relates to a connecting hole structure, and particularly to a connecting hole having a teeth-like configuration adapted to connect different parties, mainly in between of a positioning bracket, a protective sheath, an extension rod, or a connector for holding a mobile device, a tablet computer, an electronic book, a video game console, or a case.

2. Related Art

A conventional positioning bracket for a mobile device is disclosed in Taiwan Patent No.: M457113. The conventional positioning bracket is intended to hold a mobile device and is movable and has a connector for connecting the positioning bracket and a securing member so as to allow the positioning bracket to be rotatable. The securing member is intended to be secured on an external article so as to suspend the positioning bracket to hold the mobile device. The connector has a first connecting portion and a second connecting portion both detachably disposed on opposite sides of the connector for connecting the positioning bracket and the securing member. In this manner, the connector is capable of being connected with the positioning bracket and the securing member, and the mobile device is therefore rotated at different angles in conjunction with rotation of the first connecting portion or the second connecting portion as well as with the positioning bracket and the securing member.

Although the connector disclosed in the aforementioned prior art is capable of connecting the positioning bracket and the movable securing member and further allowing the positioning bracket to be rotatable, the connector connected to the positioning bracket and the securing member is through an engaging means, a fastening means, an embedding means, a clipping means, a magnetic suction means, a screw means, a hook-and-loop means, or an adhesive means. However, none of the above-mentioned means can provide a quickly, simply, and firmly connection for the connector, nor can they allow the positioning bracket to be rotated at various angles as required by users.

### SUMMARY OF THE INVENTION

Accordingly, an object of the present invention is to provide a connecting hole having a teeth-like configuration, disposed on a female connecting article for connecting a male connecting article, the connecting hole having a teeth-like configuration comprising: a plurality of tooth portions spaced apart from each other and arranged radially about a center of the connecting hole at a predetermined angle; and the male connecting article comprising a connecting element formed with multiple circumferentially outwardly projecting portions corresponding in position to the plurality of tooth portions so as to allow the multiple circumferentially outwardly projecting portions to pass through the connecting hole and to be positioned by rotation of the male connecting article, such that the multiple projecting portions abut against a side surface of the connecting hole, and an outer periphery of the connecting element is in frictional contact with an inner periphery of the connecting hole.

In one aspect of the present invention, the plurality of tooth portions are integrally formed with the female connecting article or detachably connected with the female connecting article. The multiple circumferentially outwardly projecting portions and the connecting element are integrally formed with the male connecting article or are detachably connected with the male connecting article.

In another aspect of the present invention, the female connecting article or the male connecting article is one of an extension rod, a positioning device, a protective sheath, an adjustable sheath, a fixing element, a portable device, a tablet PC, an electronic book, an electronic game console, a case and a cable. Each of the plurality of tooth portions is arranged radially about the center of the connecting hole at a predetermined equiangular or at a predetermined non-equiangular, so as to form a symmetrical or an asymmetrical configuration. Each of the plurality of tooth portions has a round, arc, triangle, or polygonal profile and is connected with each other to form the teeth-like configuration.

In another aspect of the present invention, the multiple projecting portions are in alignment with the plurality of tooth portions in order to pass through the connecting hole, and after the multiple projecting portions pass through the connecting hole, the male connecting article is being rotated to enable the multiple projecting portions to be in non-alignment with the plurality of the tooth portions. Furthermore, the rotation of the male connecting article to be assembled with the connecting hole is in response to the friction between the outer periphery of the connecting element and the inner periphery of the connecting hole, whereby generating a frictional sound along with the rotation.

Another object of the present invention is to provide a connecting hole having a teeth-like configuration, disposed on a female connecting article for connecting a male connecting article, the connecting hole having a teeth-like configuration comprising: a plurality of tooth portions spaced apart from each other and arranged radially about a center of the connecting hole at a predetermined angle; and the male connecting article comprising a connecting element formed with multiple circumferentially outwardly projecting portions corresponding in position to the plurality of tooth portions so as to allow the multiple circumferentially outwardly projecting portions to pass through and engage the connecting hole in such a way that the connecting element is capable of being squeezed to pass through the connecting hole and enable the multiple projecting portions to be engaged with a side surface of the connecting hole.

In one aspect of the present invention, the connecting element of the male connecting article has a hollow portion formed therein to enable the connecting element to be depressible so as to be mounted in the connecting hole. Furthermore, the connecting element has a depressed portion for being depressed to enable the connecting element to be mounted in the connecting hole.

With the foregoing structure of the connecting hole, the connecting hole disposed on the female connecting article of the present invention is capable of being quickly, simply and firmly connected to the male connecting article though the teeth-like configuration. Moreover, the female connecting article is rotatable through the connecting hole. As a result, users can use the connecting hole having the teeth-like configuration to connect various kinds of female connecting articles and male connecting articles without limitations of locations and places. Accordingly, the connecting hole having the teeth-like configuration of the present invention successfully overcomes the drawback of inconvenient and inefficient connection brought by the conventional connector.

### BRIEF DESCRIPTION OF THE DRAWINGS

FIG. 1 is a schematic perspective view showing a connecting hole having a teeth-like configuration of the present invention that is disposed on a positioning bracket;

FIG. 2 is a schematic perspective view of a male connecting article for being connected with the connecting hole of the present invention;

FIG. 3 is another perspective view of the male connecting article;

FIG. 4 is a schematic perspective view showing a connecting element assembled with the male connecting article;

FIG. 5 is a schematic explode view of the positioning bracket and the male connecting article of the present invention;

FIG. 6 is a perspective assembled view of FIG. 5;

FIG. 7 is a schematic cross-sectional view of the connecting hole of the present invention;

FIG. 8 is a front elevational view of the male connecting article;

FIG. 9 is a schematic cross-sectional view showing a second embodiment of the connecting hole;

FIG. 10 is a schematic cross-sectional view showing a third embodiment of the connecting hole;

FIG. 11 is a schematic cross-sectional view showing a fourth embodiment of the connecting hole;

FIG. 12 is a schematic cross-sectional view showing the connecting element passing through the connecting hole;

FIG. 13 is a schematic cross-sectional view showing a second embodiment of the connecting element passing through the connecting hole; and

FIG. 14 is a schematic cross-sectional view showing a third embodiment of the connecting element passing through the connecting hole.

### DESCRIPTION OF THE PREFERRED EMBODIMENTS

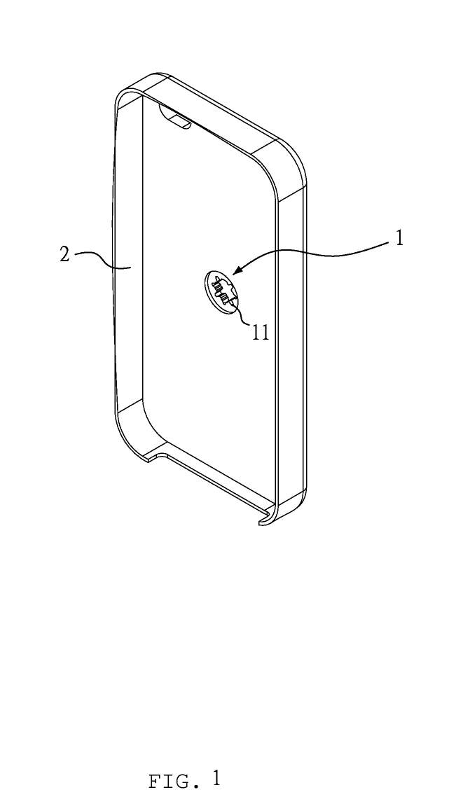

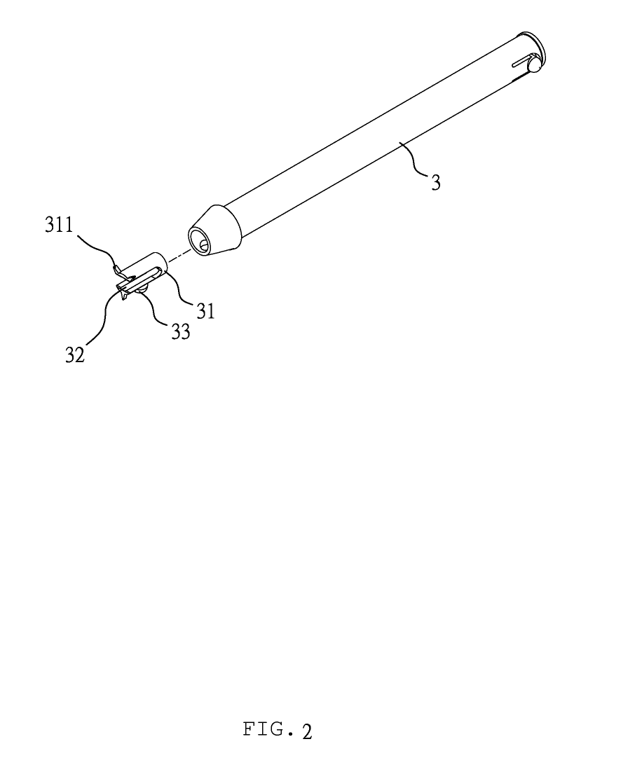

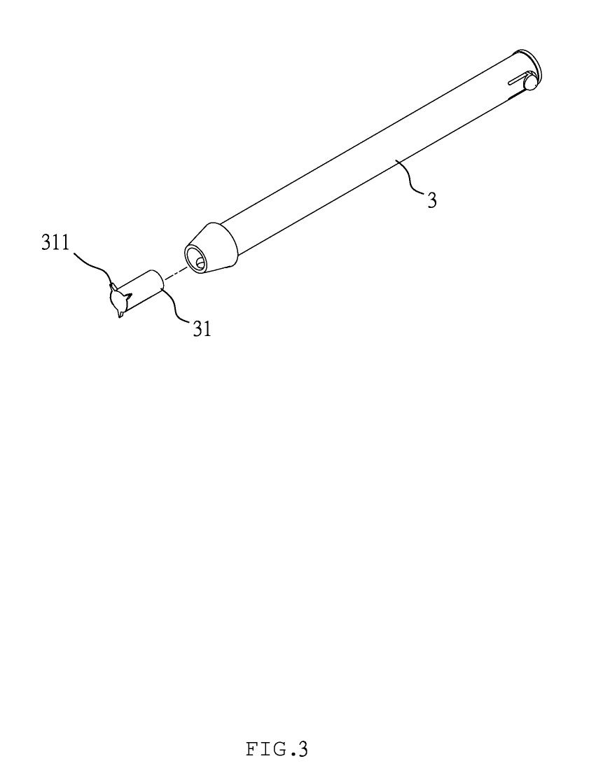

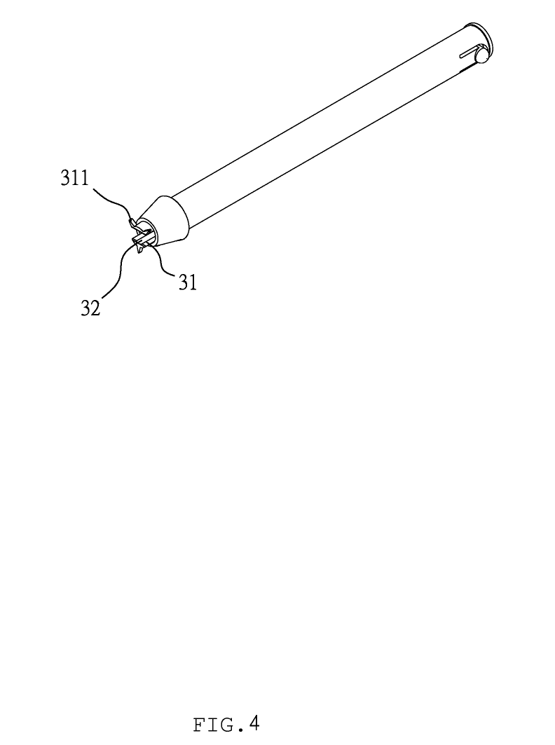

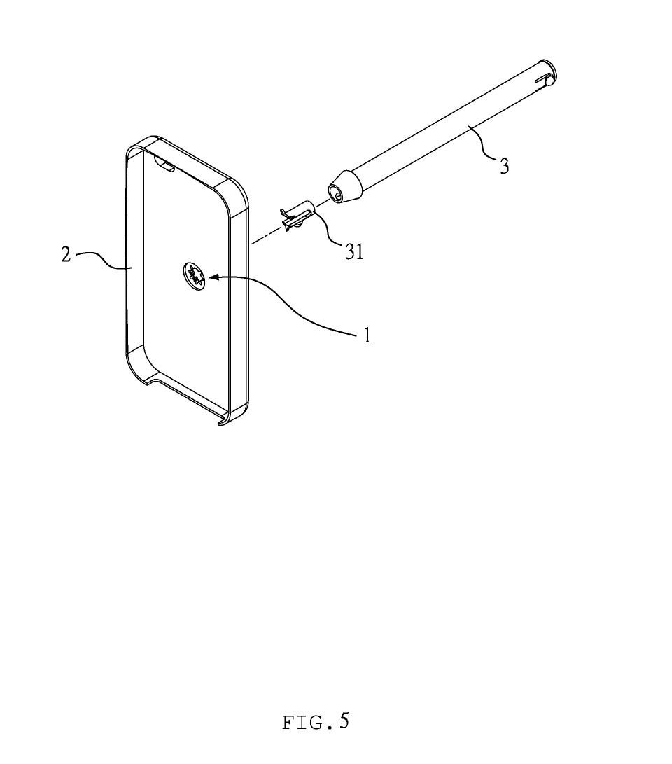

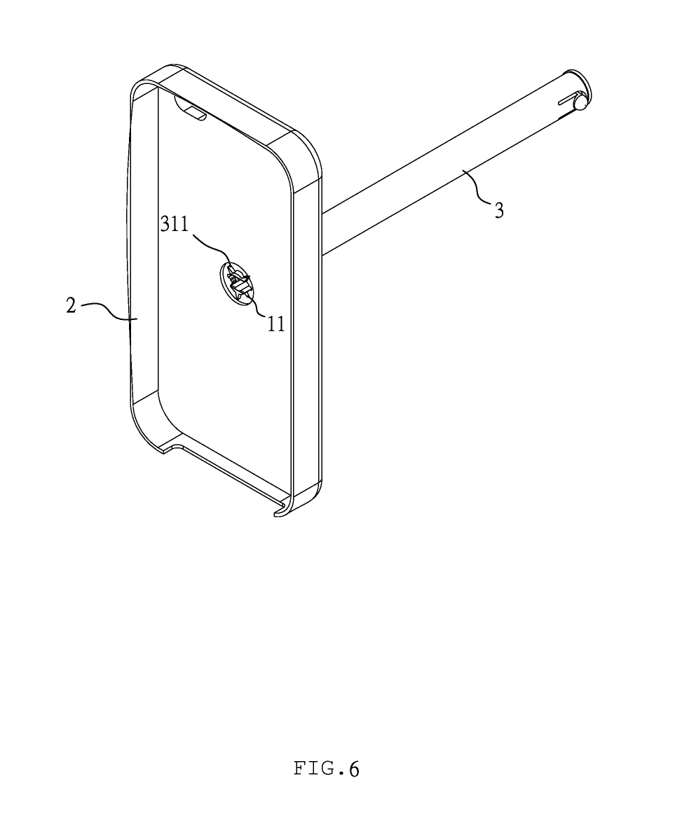

Referring to FIGS. 1 to 8 showing a connecting hole 1 having a teeth-like configuration of the present invention, which is disposed on a female connecting article, the female connecting article is exemplified as a positioning bracket 2 in this preferable embodiment. The connecting hole 1 having the teeth-like configuration is disposed on the positioning bracket 2 for connecting a male connecting article which is exemplified as a securing member 3. The securing member 3 is intended to be secured on an external article and suspend the positioning bracket 2 for holding a mobile device (not shown). The securing member 3 in this embodiment is exemplified as an extension rod which functions as a positioning device, wherein one end of securing member 3 is detachably connected with a connecting element 31. The connecting hole 1 is capable of being detachably disposed on the positioning bracket 2 or, as depicted in this embodiment, is integrally formed with the positioning bracket 2. The purpose that the connecting element 1 is detachably connected with the securing member 3 is to simplify manufacture and provide convenience of carrying and quick assembling for users. As shown in FIG. 2, the connecting element 31 comprises a hollow portion 32 formed therein and penetrating a front end of the connecting element 31 so as to divide the connecting element 31 into upper and lower portions. In this manner, the hollow portion 32 enables the connecting element 31 to be deformable and depressible so as to be mounted into the connecting hole 1 that has a diameter slightly smaller than a diameter of the connecting element 31. Alternatively, as shown in FIG. 3, the connecting element 31 is in a solid state without forming the hollow portion 32 and is made of a material having a flexibility quality so as to be depressed to fit in the connecting hole 1.

A feature of the connecting hole 1 of the present invention is that the connecting hole 1 has a teeth-like configuration comprising a plurality of tooth portions 11 spaced apart from each other and arranged radially about a center of the connecting hole 1 at a predetermined angle. The connecting element 31 of the securing member 3 comprises multiple circumferentially outwardly projecting portions 311 corresponding in position to the plurality of tooth portions 11 so as to allow the circumferentially outwardly projecting portions 311 to pass through the connecting hole 1, wherein each of the multiple circumferentially outwardly projecting portions 311 has a length larger than a length of each of the plurality of tooth portions 11. More specifically, the connecting element 31 is being depressed to reduce a diameter thereof and the multiple projecting portions 311 are to be placed in alignment with the corresponding tooth portions 11 so as to pass through the tooth portions 11 and the connecting hole 1. After the multiple projecting portions 311 pass though the connecting hole 1, the upper and lower portions of the connecting element 31 are expanded to abut against the connecting hole 1 such that the multiple projecting portions 311 abut against a side surface of the connecting hole 1, and an outer periphery of the connecting element 31 is in frictional contact with an inner periphery of the connecting hole 1. After the connecting element 31 is mounted into the connecting hole 1 in place, the connecting hole 1 is positioned between the multiple circumferentially outwardly projecting portions 311 and one end of the securing member 3. Furthermore, the connecting element 31 is rotatable in a clockwise direction or a counterclockwise direction to enable the multiple projecting portions 311 to be in non-alignment with the plurality of the tooth portions 11 in such a way as to form an interleaving format between the tooth portions 11 and the multiple projecting portions 311 and to generate frictional contact therebetween. In this manner, the rotation of the connecting element 31 of the securing member 3 to be assembled with the connecting hole 1 is in response to the friction contact between the outer periphery of the connecting element 31 and the inner periphery of the connecting hole 1, whereby generating a frictional sound along with the rotation. Likewise, the positioning bracket 2 is rotatable about the connecting element 31 and is capable of being positioned with an engagement of the plurality of tooth portions 11 and the multiple projecting portions 311.

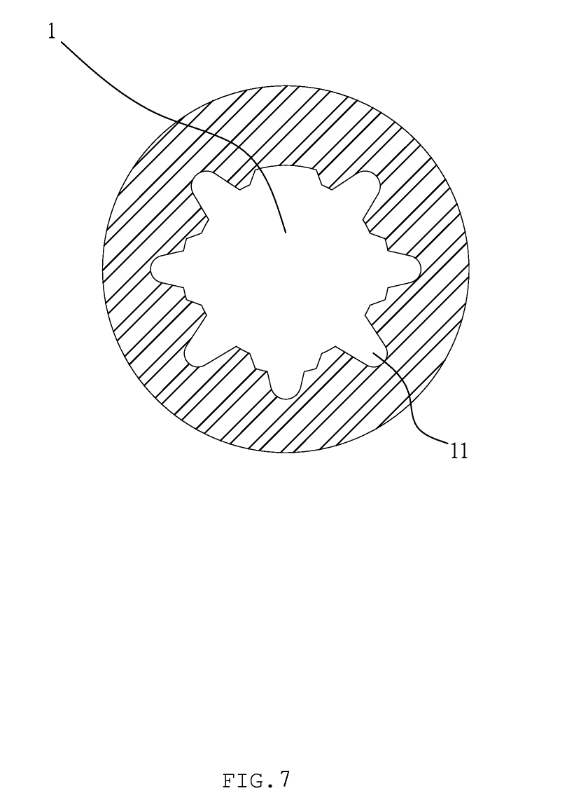

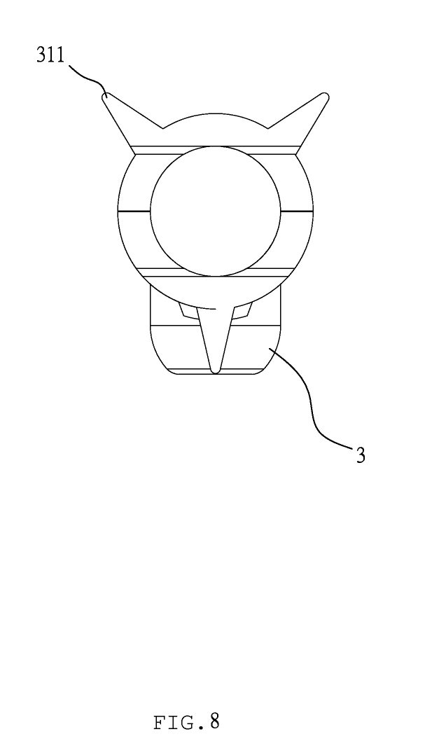

Referring to FIG. 2, the connecting element 31 has at least a depressed portion 33 formed on one side of the hollow portion 32 for being depressed to enable the connecting element 31 to be mounted in the connecting hole 1. The depressed portion 33 is integrally formed with the connecting element 31 and is depressible to deform the connecting element 31 through the hollow portion 32, whereby enabling the connecting element 31 to fit into the connecting hole 1. In a preferable embodiment, each of the plurality of tooth portions 11 is arranged radially about the center of the connecting hole 1 at a predetermined equiangular or at a predetermined non-equiangular, so as to form a symmetrical or an asymmetrical configuration. Furthermore, each of the plurality of tooth portions 11 has a same size as one another or a different size than one another. Specifically, each of the plurality of tooth portions 11 has a round, arc, triangle, or polygonal profile and is connected with each other to form the teeth-like configuration. Still further, number of the multiple circumferentially outwardly projecting portions 311 is less or more than or equal to number of the plurality of tooth portions 11. The purpose of determining number and size of the plurality of tooth portions 11 and the multiple projecting portions 311 is to ensure that the multiple projecting portions 311 are capable of passing through the plurality of tooth portions 11 so as to be assembled with the connecting hole 1. As shown in FIGS. 7 and 8, the connecting hole 1 has seven tooth portions 11, while the connecting element 31 has three projecting portions 311, wherein each of the seven tooth portions 11 is arranged radially about the center of the connecting hole 1 at a predetermined equiangular, except for a larger chamfer formed between two of the seven tooth portions 11 located at the top area of the connecting hole 1. It is noted that the chamfer is configured to prevent one of the projecting portions 311 from passing through the connecting hole 1 so as to ensure that the only way to eject the connecting element 31 is to rotate the multiple projecting portions 311 to be in alignment with the corresponding tooth portions 11.

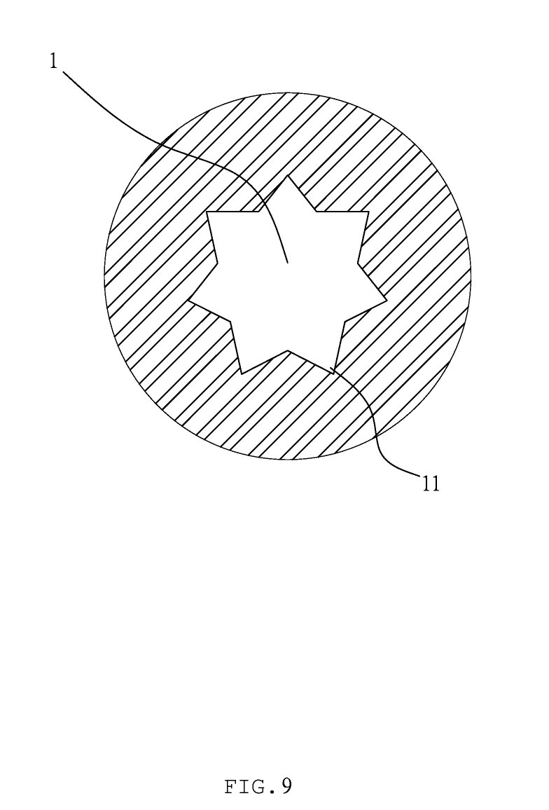

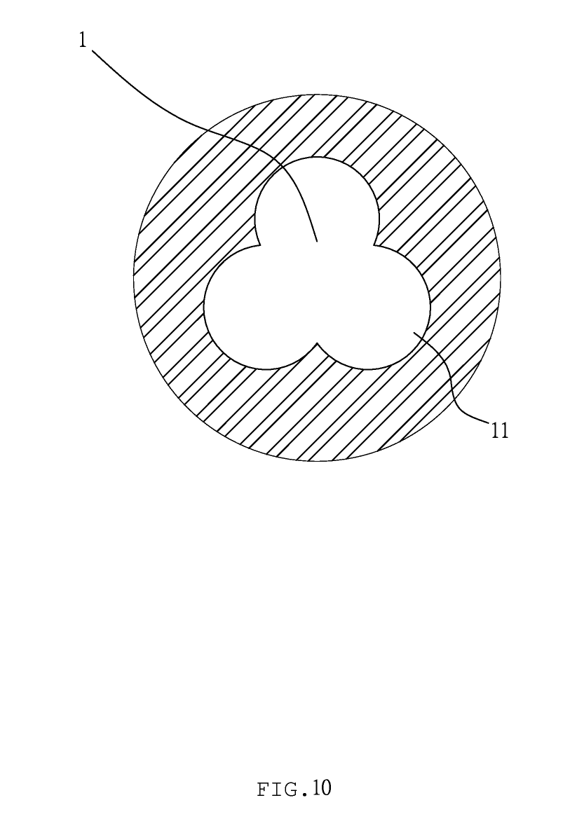

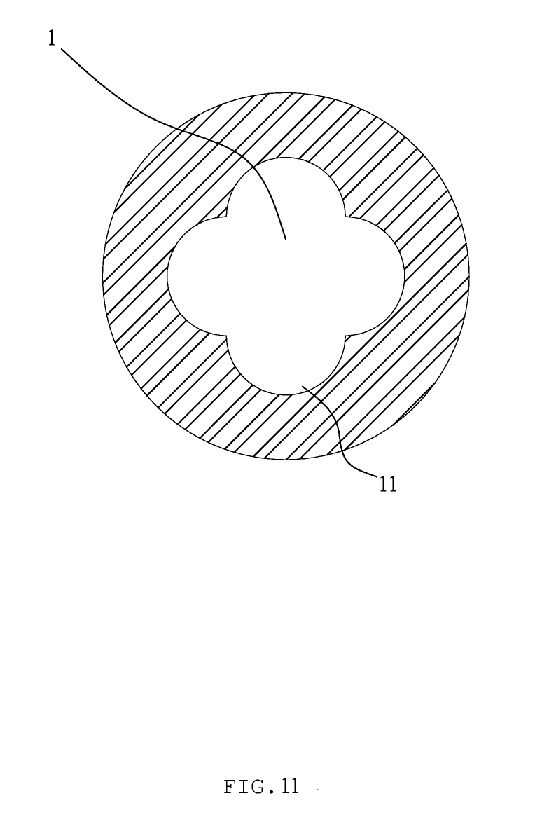

Referring to FIG. 9 showing a schematic cross-sectional view of a second embodiment of the connecting hole 1, the connecting hole 1 in this embodiment has seven tooth portions 11 each having a triangle profile and being arranged radially about the center of the connecting hole 1 at an equiangular, and each of the seven portions 11 has a same size. Furthermore, the plurality of tooth portions 11 in FIG. 9 extend from a polygonal hole instead of a round hole. Referring to FIGS. 10 and 11 respectively showing cross-sectional views of other embodiments of the connecting hole 1, the connecting hole 1 in FIG. 10 has three tooth portions 11 each having a same size round profile, and the connecting hole 1 in FIG. 11 has four tooth portions 11 each having a same size round profile, wherein the tooth portions 11 in FIGS. 10 and 11 are arranged radially about a center of the connecting hole 1 at a equiangular.

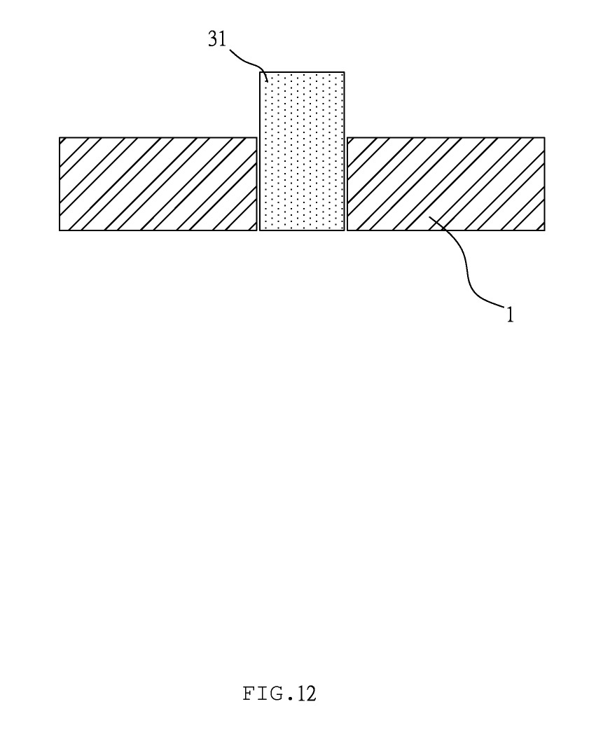

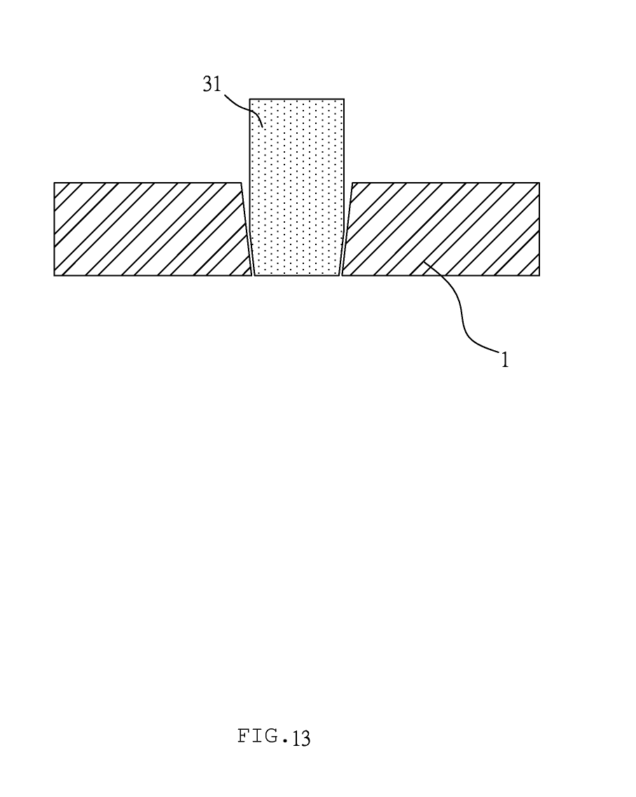

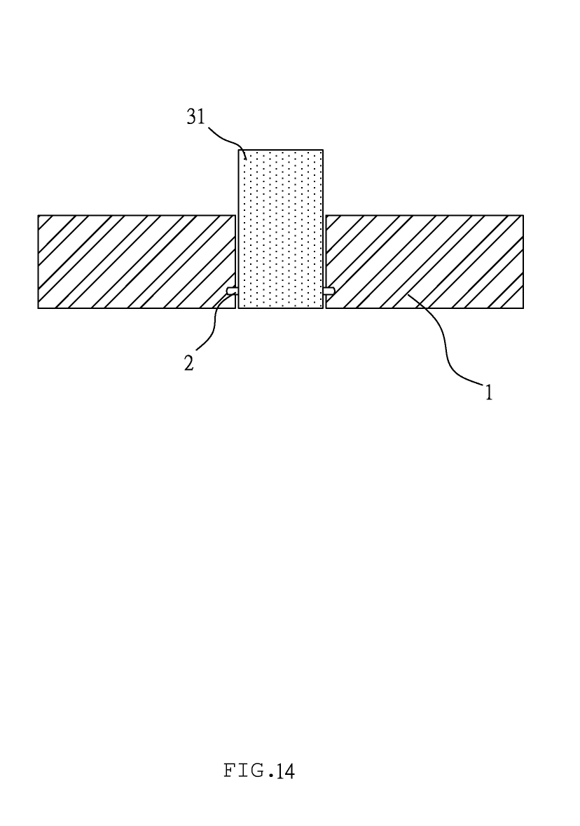

Referring to FIGS. 12 to 14 showing cross-sectional views of the connecting element 31 passing through the connecting hole 1, the connecting hole 1 and the connecting element 31 are connected through rotation or frictionally engagement, and therefore a cross section of the connecting hole 1 can be varied with respect to the connecting element 31. For example, a diameter of the connecting hole 1 is increasingly reduced in cross section in a direction of insertion of the securing member 3, as shown in FIG. 13, whereby the connecting element 31 is in snug fit engagement with the connecting hole 1. Alternatively, as shown in FIG. 12, the diameter of the connecting hole 1 remains the same in cross section in a direction of insertion of the securing member 3. In a further embodiment, as shown in FIG. 14, at least an engaging element 12 is disposed on an outer periphery of the connecting element 31. The engaging element 12 is engaged with an inner periphery of the connecting hole 1 so as to fix the connecting element 31 and the connecting hole 1.

It is understood that the invention may be embodied in other forms within the scope of the claims. Thus the present examples and embodiments are to be considered in all respects as illustrative, and not restrictive, of the invention defined by the claims.

What is claimed is:

1. A connecting hole having a teeth-like configuration, disposed on a female connecting article for connecting a male connecting article, the connecting hole having a teeth-like configuration comprising:
a plurality of tooth portions spaced apart from each other and arranged radially about a center of the connecting hole at a predetermined angle; and
the male connecting article comprising a connecting element formed with multiple circumferentially outwardly projecting portions corresponding in position to the plurality of tooth portions so as to allow the multiple circumferentially outwardly projecting portions to pass through the connecting hole and to be positioned by rotation of the male connecting article, such that the multiple projecting portions abut against a side surface of the connecting hole, and an outer periphery of the connecting element is in frictional contact with an inner periphery of the connecting hole.

2. The connecting hole having a teeth-like configuration of claim 1, wherein the plurality of tooth portions are integrally formed with the female connecting article or detachably connected with the female connecting article.

3. The connecting hole having a teeth-like configuration of claim 1, wherein the multiple circumferentially outwardly projecting portions and the connecting element are integrally formed with the male connecting article or are detachably connected with the male connecting article.

4. The connecting hole having a teeth-like configuration of claim 1, wherein the female connecting article is one of an extension rod, a positioning device, a protective sheath, an adjustable sheath, a fixing element, a portable device, a tablet PC, an electronic book, an electronic game console, a case and a cable.

5. The connecting hole having a teeth-like configuration of claim 1, wherein the male connecting article is one of an extension rod, a positioning device, a protective sheath, an adjustable sheath, a fixing element, a portable device, a tablet computer, an electronic book, an electronic game console, a case and a cable.

6. The connecting hole having a teeth-like configuration of claim 1, wherein each of the plurality of tooth portions is arranged radially about the center of the connecting hole at a predetermined equiangular or at a predetermined non-equiangular, so as to form a symmetrical or an asymmetrical configuration.

7. The connecting hole having a teeth-like configuration of claim 1, wherein each of the plurality of tooth portions has a same size as one another or a different size than one another.

8. The connecting hole having a teeth-like configuration of claim 1, wherein each of the plurality of tooth portions has a round, arc, triangle, or polygonal profile and is connected with each other to form the teeth-like configuration.

9. The connecting hole having a teeth-like configuration of claim 1, wherein number of the multiple circumferentially outwardly projecting portions is equal or unequal to number of the plurality of tooth portions.

10. The connecting hole having a teeth-like configuration of claim 1, wherein the multiple projecting portions are to be placed in alignment with the plurality of tooth portions in order to pass through the connecting hole, and after the multiple projecting portions pass through the connecting hole, the male connecting article is being rotated to enable the multiple projecting portions to be in non-alignment with the plurality of the tooth portions in such a way as to form an interleaving format between the tooth portions and the multiple projecting portions, and in order to provide a better connection therebetween with the frictional contact.

11. The connecting hole having a teeth-like configuration of claim 1, wherein the rotation of the male connecting article to be assembled with the connecting hole is in response to the friction between the outer periphery of the connecting element and the inner periphery of the connecting hole, whereby generating a frictional sound along with the rotation.

12. The connecting hole having a teeth-like configuration of claim 1, wherein a diameter of the connecting hole is increasingly reduced in cross section in a direction of insertion of the male connecting article, or the diameter of the connecting hole remains the same in cross section in a direction of insertion of the male connecting article.

13. The connecting hole having a teeth-like configuration of claim 1, wherein the connecting element of the male connecting article has a hollow portion formed therein to enable the connecting element to be depressible so as to be mounted in the connecting hole.

14. The connecting hole having a teeth-like configuration of claim 1, wherein the connecting element has a depressed portion for being depressed to enable the connecting element to be mounted in the connecting hole.

15. A connecting hole having a teeth-like configuration, disposed on a female connecting article for connecting a male connecting article, the connecting hole having a teeth-like configuration comprising:
a plurality of tooth portions spaced apart from each other and arranged radially about a center of the connecting hole at a predetermined angle; and
the male connecting article comprising a connecting element formed with multiple circumferentially outwardly projecting portions corresponding in position to the plurality of tooth portions so as to allow the multiple circumferentially outwardly projecting portions to pass through and engage the connecting hole in such a way that the connecting element is squeezed to pass through the connecting hole and enable the multiple projecting portions to be engaged with a side surface of the connecting hole.

16. The connecting hole having a teeth-like configuration of claim 15, wherein each of the plurality of tooth portions has a round, arc, triangle, or polygonal profile and is connected with each other to form the teeth-like configuration.

17. The connecting hole having a teeth-like configuration of claim 15, wherein after the connecting element is mounted into the connecting hole, the connecting hole is being positioned between the multiple circumferentially outwardly projecting portions and one end of the male connecting article.

18. The connecting hole having a teeth-like configuration of claim 15, wherein each of the multiple circumferentially outwardly projecting portions has a length larger than a length of each of the plurality of tooth portions.

19. The connecting hole having a teeth-like configuration of claim 15, wherein the female connecting article is rotatable about the connecting element and is capable of being positioned with an engagement between the plurality of tooth portions and the multiple projecting portions.

20. The connecting hole having a teeth-like configuration of claim 15, wherein the connecting element of the male connecting article has a hollow portion formed therein to enable the connecting element to be depressible so as to be mounted in the connecting hole.
